(19) United States
(12) Patent Application Publication
(10) Pub. No.: US 2024/0359560 A1
(43) Pub. Date: Oct. 31, 2024

(54) BATTERY MANAGEMENT SYSTEM FOR AN ELECTRIC VEHICLE

(71) Applicant: JOULES MILES CO., LTD., Kaohsiung City (TW)

(72) Inventor: Tao-Cheng WU, Kaohsiung City (TW)

(21) Appl. No.: 18/355,951

(22) Filed: Jul. 20, 2023

(30) Foreign Application Priority Data
Apr. 25, 2023 (TW) 112115346

(51) Int. Cl. B60L 1/00; H02J 7/00

(52) U.S. Cl. CPC B60L 1/00; H02J 7/00032; H02J 7/0029; H02J 7/0063; H02J 2207/20

(57) ABSTRACT

A battery management system includes a microcontroller, a switch circuit, a DC-to-DC converter and an automatic termination circuit. The switch circuit is adapted to be connected to a battery of an electric vehicle, and is configured to receive an operation command indicating that the microcontroller should be powered or not be powered. The DC-to-DC converter is connected to the switch circuit and the microcontroller. The automatic termination circuit is connected to the microcontroller and the switch circuit, and is configured to receive the operation command, detect an operation state of the microcontroller, obtain a time length based on the operation command and the operation state of the microcontroller, and, when the time length is greater than a predetermined threshold, output a termination command for receipt by the switch circuit so as to cause the switch circuit to break an electrical connection between the battery and the DC-to-DC converter.

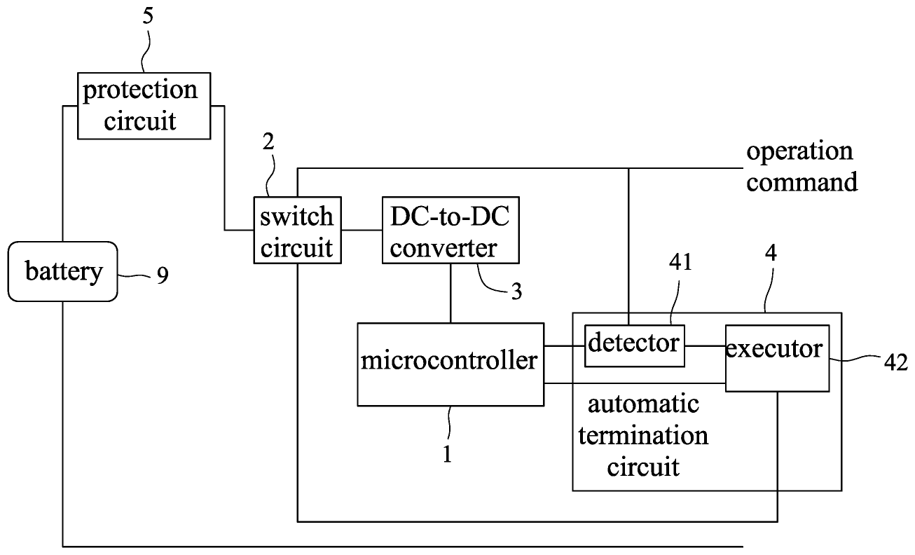

### CROSS-REFERENCE TO RELATED APPLICATION

This application claims priority to Taiwanese Patent Application No. 112115346, filed on Apr. 25, 2023.

### FIELD

The disclosure relates to a battery management system, and more particularly to a battery management system for an electric vehicle.

### BACKGROUND

Electric vehicles are becoming more and more popular in the market. Because of advancements in battery technology, an electric vehicle can use a battery with significantly increased power capacity to achieve a considerable mileage and to satisfy the power demands of various multimedia devices and remote control functions. However, when a conventional electric vehicle is not running, a user would operate a main power switch of the conventional electric vehicle to power off the conventional electric vehicle, but power stored in the battery would still be consumed if the conventional electric vehicle is designed to provide background functions such as the conventional electric vehicle may be woken up at any time from a standby state, the conventional electric vehicle may monitor the surrounding environment continuously and initiate a contingency action conditionally, or the conventional electric vehicle may be remotely controlled by the user through a portable smart device at any time, etc. Whether it is to protect the environment or to increase the mileage of the electric vehicle, it is important to reduce unnecessary power consumption from the battery with limited power capacity.

### SUMMARY

Therefore, an object of the disclosure is to provide a battery management system that can reduce unnecessary power consumption.

According to an aspect of the disclosure, the battery management system is operatively associated with a battery of an electric vehicle, and includes a microcontroller, a switch circuit, a direct current (DC)-to-DC converter and an automatic termination circuit. The switch circuit is adapted to be connected to the battery, and is configured to receive an operation command indicating that the microcontroller should be powered or not be powered. The DC-to-DC converter is connected to the switch circuit and the microcontroller. The automatic termination circuit is connected to the microcontroller and the switch circuit, and is configured to receive the operation command, detect an operation state of the microcontroller, obtain a time length based on the operation command and the operation state of the microcontroller, and, when the time length is greater than a predetermined threshold, output a termination command for receipt by the switch circuit so as to cause the switch circuit to break an electrical connection between the battery and the DC-to-DC converter.

According to another aspect of the disclosure, the battery management system is operatively associated with a battery of an electric vehicle, and includes a microcontroller, a switch circuit, a DC-to-DC converter and an automatic termination circuit. The switch circuit is adapted to be connected to the battery, and is configured to receive an operation command indicating that the microcontroller should be powered or not be powered. The DC-to-DC converter is connected to the switch circuit and the microcontroller. The automatic termination circuit is connected to the microcontroller and the switch circuit, and is configured to receive the operation command, detect an operation state of the microcontroller, and, when the indication of the operation command and the operation state of the microcontroller are inconsistent, output a termination command for receipt by said microcontroller so as to shut down the microcontroller.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

The FIGURE is a block diagram illustrating an embodiment of a battery management system for an electric vehicle according to the disclosure.

### DETAILED DESCRIPTION

Referring to the FIGURE, an embodiment of a battery management system according to the disclosure is operatively associated with a battery 9 of a vehicle, and includes a microcontroller 1, a switch circuit 2, a direct current (DC)-to-DC converter 3, an automatic termination circuit 4 and a protection circuit 5. The protection circuit 5 is adapted to be connected between the battery 9 and the switch circuit 2. The DC-to-DC converter 3 is connected to the switch circuit 2 and the microcontroller 1. The automatic termination circuit 4 is connected to the microcontroller 1 and the switch circuit 2. The microcontroller 1 is configured to control various operations of the electric vehicle. The switch circuit 2 is configured to receive an operation command indicating that the microcontroller 1 should be powered or not be powered. In this embodiment, the operation command is generated by a key switch based on an operation performed thereon by a user. However, in other embodiments, the operation command may be generated by a component supporting keyless control.

The protection circuit 5 is configured to provide a protection mechanism. For example, the protection circuit 5 includes a fuse that provides overcurrent protection, or a component that provides load control. The switch circuit 2 is operable to establish and break an electrical connection between the protection circuit 5 and the DC-to-DC converter 3 based on the operation command. When the operation command indicates that the microcontroller 1 should be powered, the switch circuit 2 establishes the electrical connection between the protection circuit 5 and the DC-to-DC converter 3, the DC-to-DC converter 3 receives input DC power from the battery 9 through the protection circuit 5 and the switch circuit 2, and converts the input DC power into output DC power for receipt by the microcontroller 1, so that the microcontroller 1 is powered. When the operation command indicates that the microcontroller 1 should not be powered, the switch circuit 2 breaks the electrical connection between the protection circuit 5 and the DC-to-DC converter 3, the DC-to-DC converter 3 does not operate, and the microcontroller 1 is not powered. By virtue of the DC-to-DC converter 3, the microcontroller 1 can be powered stably, and thus can operate properly.

The automatic termination circuit 4 includes a detector 41 and an executor 42. The detector 41 is connected to the microcontroller 1, and is configured to receive the operation command, detect an operation state of the microcontroller 1, obtain a time length based on the operation command and the operation state of the microcontroller 1, and determine whether the indication of the operation command and the operation state of the microcontroller 1 are inconsistent. The executor 42 is connected to the detector 41, the microcontroller 1 and the switch circuit 2, and is configured to receive the time length obtained by the detector 41 and a result of the determination made by the detector 41, and perform: (a) when the time length is greater than a predetermined threshold, outputting a first termination command for receipt by the switch circuit 2 so as to cause the switch circuit 2 to break the electrical connection between the protection circuit 5 and the DC-to-DC converter 3; and (b) when the result of the determination indicates that the indication of the operation command and the operation state of the microcontroller 1 are inconsistent, outputting a second termination command for receipt by the microcontroller 1 so as to shut down the microcontroller 1.

In this embodiment, the time length is a length of a time interval during which the operation command constantly indicates that the microcontroller 1 should be powered and the operation state of the microcontroller 1 is constantly an idle state, and the predetermined threshold is, for example, thirty minutes. Therefore, when the microcontroller 1 is powered and operates in the idle state for thirty minutes (i.e., there is unnecessary power consumption), the executor 42 would output the first termination command, so that the microcontroller 1 is no longer powered, thereby reducing unnecessary power consumption.

In this embodiment, the executor 42 outputs the second termination command when the operation command indicates that the microcontroller 1 should not be powered but the operation state of the microcontroller 1 is a working state (i.e., abnormal operation occurs), so as to shut down the microcontroller 1, thereby reducing unnecessary power consumption and preventing various component failures.

The conventional battery management system consumes a current of about 500 μA even when it operates in a sleep mode. However, the battery management system of this embodiment can be designed to consume a current of about 30 μA (which is lower than 10% of 500 μA) in some conditions, thereby enhancing power efficiency.

In this embodiment, after the switch circuit 2 breaks the electrical connection between the protection circuit 5 and the DC-to-DC converter 3 in response to the receipt of the first termination command, the switch circuit 2 establishes the electrical connection between the protection circuit 5 and the DC-to-DC converter 3 again when first receiving the operation command indicating that the microcontroller 1 should not be powered and then receiving the operation command indicating that the microcontroller 1 should be powered. Therefore, after the switch circuit 2 breaks the electrical connection between the protection circuit 5 and the DC-to-DC converter 3 in response to the receipt of the first termination command, the user has to first operate the key switch to generate the operation command indicating that the microcontroller 1 should not be powered, and then operate the key switch to generate the operation command indicating that the microcontroller 1 should be powered, so that the switch circuit 2 can establish the electrical connection between the protection circuit 5 and the DC-to-DC converter 3 again. This can improve user experience, and can ensure proper operation of the battery management system of this embodiment

In view of the above, by virtue of the automatic termination circuit 4 causing the switch circuit 2 to break the electrical connection between the protection circuit 5 and the DC-to-DC converter 3 when the microcontroller 1 operates in the idle state for a long time, and by virtue of the automatic termination circuit 4 shutting down the microcontroller 1 when abnormal operation occurs, unnecessary power consumption from the battery 9 can be reduced, and safe operation of the microcontroller 1 can be ensured.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A battery management system operatively associated with a battery of an electric vehicle, and comprising:
a microcontroller;
a switch circuit adapted to be connected to the battery, and configured to receive an operation command indicating that said microcontroller should be powered or not be powered;
a direct current (DC)-to-DC converter connected to said switch circuit and said microcontroller; and
an automatic termination circuit connected to said microcontroller and said switch circuit, and configured to receive the operation command, detect an operation state of said microcontroller, obtain a time length based on the operation command and the operation state of said microcontroller, and, when the time length is greater than a predetermined threshold, output a first termination command for receipt by said switch circuit so as to cause said switch circuit to break an electrical connection between the battery and said DC-to-DC converter.

2. The battery management system as claimed in claim 1, wherein, when the indication of the operation command and the operation state of said microcontroller are inconsistent, said automatic termination circuit outputs a second termination command for receipt by said microcontroller so as to shut down said microcontroller.

3. The battery management system as claimed in claim 2, wherein after said switch circuit breaks the electrical connection between the battery and said DC-to-DC converter in response to the receipt of the first termination command, said switch circuit establishes the electrical connection between the battery and said DC-to-DC converter when first receiving the operation command indicating that said microcontroller should not be powered and then receiving the operation command indicating that said microcontroller should be powered.

4. The battery management system as claimed in claim 2, wherein said automatic termination circuit outputs the second termination command when the operation command indicates that said microcontroller should not be powered and the operation state of said microcontroller is a working state.

5. The battery management system as claimed in claim 1, wherein after said switch circuit breaks the electrical connection between the battery and said DC-to-DC converter in response to the receipt of the first termination command, said switch circuit establishes the electrical connection between the battery and said DC-to-DC converter when first receiving the operation command indicating that said microcontroller should not be powered and then receiving the operation command indicating that said microcontroller should be powered.

6. The battery management system as claimed in claim 1, further comprising a protection circuit that is adapted to be connected between the battery and said switch circuit.

7. The battery management system as claimed in claim 1, wherein the time length is a length of a time interval during which the operation command constantly indicates that said microcontroller should be powered and the operation state of said microcontroller is constantly an idle state.

8. A battery management system operatively associated with a battery of an electric vehicle, and comprising:
a microcontroller;
a switch circuit adapted to be connected to the battery, and configured to receive an operation command indicating that said microcontroller should be powered or not be powered;
a direct current (DC)-to-DC converter connected to said switch circuit and said microcontroller; and
an automatic termination circuit connected to said microcontroller and said switch circuit, and configured to receive the operation command, detect an operation state of said microcontroller, and, when the indication of the operation command and the operation state of said microcontroller are inconsistent, output a termination command for receipt by said microcontroller so as to shut down said microcontroller.

9. The battery management system as claimed in claim 8, further comprising a protection circuit that is adapted to be connected between the battery and said switch circuit.

10. The battery management system as claimed in claim 8, wherein said automatic termination circuit outputs the termination command when the operation command indicates that said microcontroller should not be powered and the operation state of said microcontroller is a working state.
